(19) United States
(12) Patent Application Publication
(10) Pub. No.: US 2018/0313397 A1
(43) Pub. Date: Nov. 1, 2018

(54) TORQUE KEYS

(71) Applicants: Blair A. BUTLER, San Diego, CA (US); Eric G. NELSON, Boise, ID (US); John W. GODDEN, San Diego, CA (US); HP INDIGO B.V., Amstelveen (NL)

(72) Inventors: Blair A. Butler, San Diego, CA (US); Eric G. Nelson, Eagle, ID (US); John W. Godden, San Diego, CA (US)

(73) Assignee: HP INDIGO B.V., Amstelveen (NL)

(21) Appl. No.: 15/771,342

(22) PCT Filed: Apr. 6, 2016
(86) PCT No.: PCT/US2016/026254

§ 371 Date: Apr. 30, 2018

(51) Int. Cl. F16C 3/02; B65H 5/06

(52) U.S. Cl. CPC F16C 3/02; B65H 5/06; F16C 2361/41; F16C 2226/76; B65H 2403/732

(57) ABSTRACT

In an example, a torque key may include a body to mate with a wheel, a plurality of driving lugs extending radially outward from the body, and a plurality of key lugs extending radially into the body. The body may have an inner bore to receive a shaft, each driving lug may engage with a driven lug protruding from an axial face of the wheel, and each key lug may engage with a slot of the shaft.

### BACKGROUND

Imaging systems may print, scan, copy, or perform other actions with media. Further, imaging systems may include feeding or picking systems to load the media and deliver or drive the media through the imaging system for performing operations on or with the media. The imaging systems may scan the media for markings or patterns, deposit printing liquid, such as ink or another printing substance, on the media, and/or may produce duplicates of the media, including markings or patterns thereon, in addition to other functions. Further, imaging systems may include rollers to assist in delivering media through a media path of the imaging system, or to engage with other components of the imaging system.

### BRIEF DESCRIPTION OF THE DRAWINGS

FIG. 1 is a perspective view of an example torque key.

FIG. 2A is a perspective view of an example wheel set having an example torque key.

FIG. 2B is a front view of an example wheel set having an example torque key.

FIG. 3A is an exploded view of an example shaft assembly including an example torque key.

FIG. 3B is a front view of an example shaft assembly including an example torque key.

FIG. 4A is an exploded view of an example shaft assembly including an example torque key.

FIG. 4B is a front view of an example shaft assembly including an example torque key.

### DETAILED DESCRIPTION

Imaging systems or devices may include scanning systems, copying systems, printing or plotting systems, presses, or other systems that perform actions or operations on or with media, sometimes referred to as print media. Imaging systems may deposit printing liquid, such as ink, or another printing substance, on media. The imaging system may deposit printing substance on media that is fed through the imaging system from a roll of media. In other situations, the media may be picked from a stack or ream of media for use in the imaging system, or media may be fed into the imaging system one sheet at a time. Further, imaging systems may include rollers to assist in delivering media through a media path of the imaging system, or a portion thereof. The rollers may rotate with media passing over, under, or in between the rollers. Further, the rollers may be driven by the imaging device, or a driving element thereof, such as a motor, for example, in order to perform a function. In some situations, the rollers may engage with other components of the imaging device instead of media in order to perform other functions. For example, rollers may engage with printing substance delivery components.

In some situations, the rollers may include multiple components. These components may include, for example, wheels, roller wheels, gears, friction wheels or other transmission elements, as well as a shaft or multiple shafts, in some situations. The rollers, or components thereon, may engage with other rollers, gears or other components within the imaging device. The rollers may drive the other components through the engagement, or be driven by the other components. As such, in some situations, torque may be transmitted from a driving element of the imaging device to a roller in order to drive another component, and/or perform a function on the other component. In some situations, the roller may clean or absorb excess print substance off of another roller or component. Transmitting torque from the driving element to a roller may, sometimes, result in a shaft of the roller damaging a wheel, gear, or another component thereon. Additionally, an interface between such a wheel or other component and the shaft may shift or alter concentricity between the wheel and the shaft when a sufficient amount of torque is transmitted to the wheel through the interface. In some situations, the shaft may include a flat surface, or D-shaped geometry, to engage with a complementary flat surface on an inner or central bore of the wheel in order to transmit torque to the wheel. After a sufficient amount of time, or when a sufficient amount of torque is transmitted through such an interface, the flat surface on the shaft may cause a stress-concentration point on the wheel, thereby damaging the wheel, or cause the concentricity between the wheel and the shaft to change, thereby negatively affecting the performance of the roller and negatively affecting the further transmission of torque from the shaft to the wheel.

In some situations, it may be desirable to maintain tight concentricity tolerances between the wheel and the shaft. In such a situation, it may be desirable to transmit torque from the shaft to the wheel in only a rotational manner, about a longitudinal axis of the wheel and shaft. In other words, it may be desirable to avoid contact between the shaft and the wheel in a radial direction, thereby avoiding a transfer or transmission of force from the shaft to the wheel in a radial direction, and preserving concentricity between the shaft and wheel.

Implementations of the present disclosure provide examples of a torque key to engage a wheel of a roller with a shaft of the roller. The torque key examples may transmit torque from the shaft to the wheel symmetrically about a longitudinal axis of the shaft and the wheel, and, further, may avoid transmitting force from the shaft to the wheel in a radial direction. The torque key examples may, therefore, transmit torque from the shaft to the wheel without affecting a concentric relationship between the shaft and wheel, preserving the performance of the roller. Further, implementations of the present disclosure provide a torque key to transfer or transmit torque from the shaft to the wheel across a larger surface area, thereby increasing the amount of torque which may be transferred without damaging the wheel.

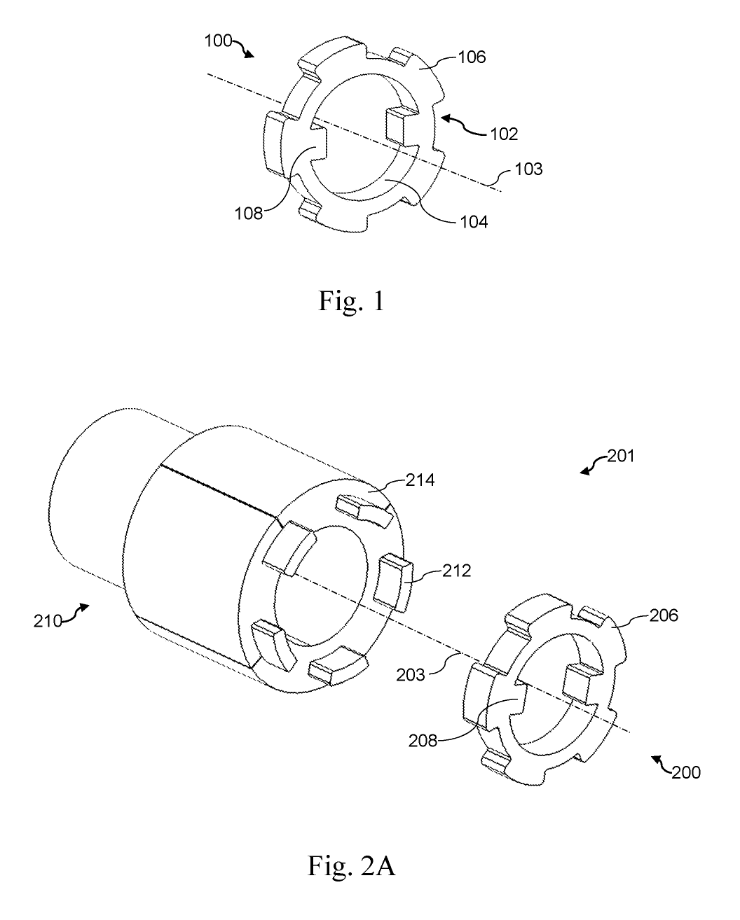

Referring now to FIG. 1, a perspective view of an example torque key 100 is illustrated. In some implementations, the torque key 100 may include a body 102, a plurality of driving lugs 106, and a plurality of key lugs 108. The body 102 may be an annular body, or, in other words, may have a round, cylindrical, or ring-shaped geometry having a center axis or longitudinal axis 103. Further, in some implementations, the torque key 100, or the body 102 thereof, may have an inner bore 104 extending into the body 102. In some implementations, the inner bore 104 may extend through the body 102. In further implementations, the inner bore 104 may be concentric to the body 102. In other words, the inner bore 104 may share the longitudinal axis 103 with the body 102. The body 102 and, more specifically, the inner bore 104 may be structured or sized to receive a shaft. In some implementations, the inner diameter (ID) of the inner bore 104 and the outer diameter (OD) of the shaft may have size tolerances sufficient to dispose the shaft and the body 102 concentrically to one another, or to dispose the shaft and the body 102 within appropriate concentricity tolerances for acceptable performance in an associated application of the torque key 100.

In some implementations, the example torque key 100 may include a plurality of key lugs 108. The key lugs 108 may be protrusions or tabs extending into the inner bore 104 of the body 102. In some implementations, the key lugs 108 may extend radially into the inner bore 104. Further, the key lugs 108 may each be sized sufficiently and have a sufficient geometry to each be received within and engage with a slot, channel, or keyway of the shaft. In some implementations, the torque key 100 may include two key lugs 108 to each be received by a separate slot of the shaft. The two key lugs 108 may be diametrically opposed to one another about the inner bore 104, in some implementations. In further implementations, the torque key 100 may include more than two key lugs 108 which may be evenly spaced about the longitudinal axis 103, or about the inner bore 104.

In some implementations, the example torque key 100 may include a plurality of driving lugs 106. Each of the plurality of driving lugs 106 may be a protrusion or tab extending outward from the body 102 of the torque key 100. In some implementations, the driving lugs 106 may extend from an outer circumference, or outer diameter of the torque key 100, or the body 102 thereof. In some implementations, the driving lugs 106 may extend radially outward from the body 102. In further implementations, the driving lugs 106 may be spaced evenly around the outer circumference of the body 102, and in yet further implementations, the driving lugs 106 may be spaced symmetrically around the outer circumference of the body 102. In some implementations, the torque key 200 may include five driving lugs 106 forming a circular pattern. Each of the driving lugs 106 may be sized sufficiently or have a sufficient geometry to engage with a driven lug extending from a wheel of a roller.

The body 102, the key lugs 108, and the driving lugs 106 may be a unitary piece defining the example torque key 100, in some implementations. In other words, the example torque key 100, and the constituent components thereof, may be constructed from a single piece of material. In other implementations, at least one of the body 102, the key lugs 108, and the driving lugs 106 may be a separate component that is assembled onto the other components to define the example torque key 100. Further, the example torque key 100, or any components thereof, in some implementations, may be formed of a metallic material such as aluminum, steel, or another suitable metallic material. In other implementations, the example torque key 100, or any of the components thereof, may be formed of another material, such as a polymer material, for example.

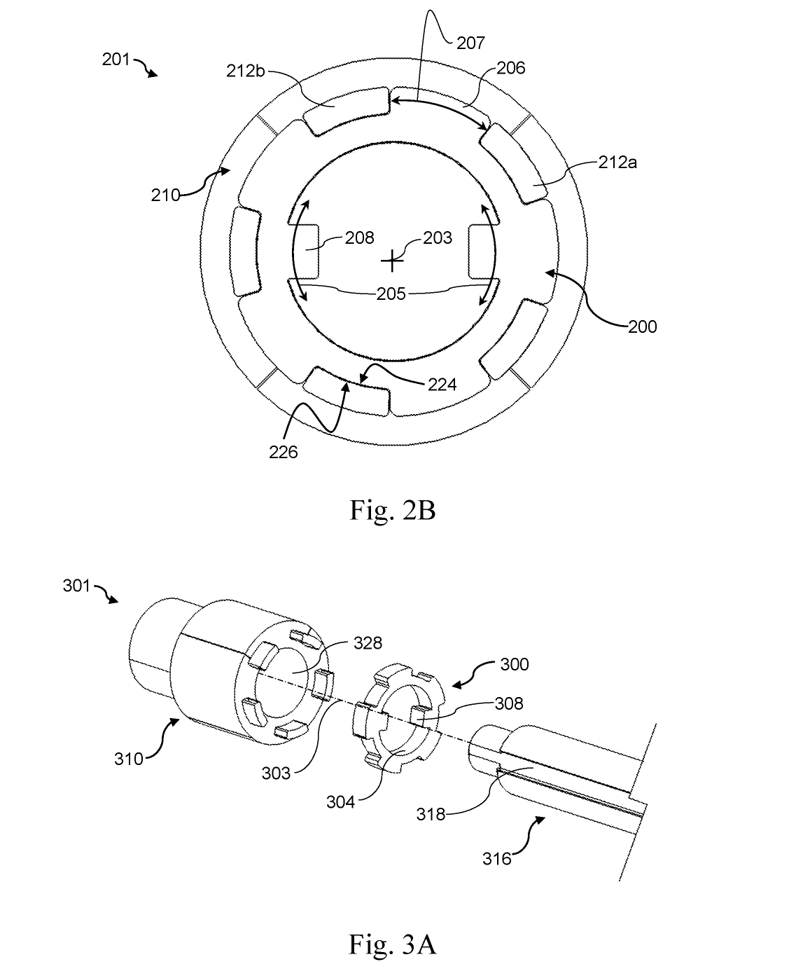

Referring now to FIG. 2A, a perspective view of an example torque key 200 is illustrated with an example wheel 210, forming an example wheel set 201. Example torque key 200 may be similar to example torque key 100. Further, the similarly named elements of example torque key 200 may be similar in function and/or structure to the elements of example torque key 100, as they are described above. In some implementations, the wheel 210 may be a round or cylindrical component having a longitudinal axis 203. The wheel 210 may be a roller, gear, friction wheel, or other rotating component of an imaging device, in some implementations. In further implementations, the wheel 210 may be a cleaner or sponge roller of an imaging device, to remove ink or another print substance from a drum or other imaging component. In further implementations, the wheel 210 may be a transmission component to engage with other components of the imaging device and transfer motion, torque, or rotation to the other component. In some implementations, the wheel 210 may include a polymer material. In further implementations, the wheel 210 may include a metallic material, or another suitable material.

The example wheel set 201 may include the example torque key 200 mated to or assembled onto the wheel 210. In further implementations, the example torque key 200 may otherwise be disposed adjacent to the wheel such that the torque key 200 may engage with the wheel 210 for the transmission of torque to the wheel 210. In some implementations, the torque key 200 may mate to or engage with an axial face 214 of the wheel 210. In some implementations, the torque key 200 may be engaged with the wheel 210 with sufficient tolerances such that the wheel 210 and the torque key 200 may share the longitudinal axis 203, or that a sufficient degree of concentricity between the two components is achieved. The torque key 200 may include a plurality of driving lugs 206, and a plurality of key lugs 208. Each of the plurality of driving lugs 206 may be structured to engage with one of a plurality of driven lugs 212 disposed on the wheel 210, when the torque key 200 is engaged with the wheel 210. In some implementations, each of the plurality of driven lugs 212 may be a protrusion or tab protruding or extending from the wheel 210. In further implementations, the plurality of driven lugs 212 may extend from the axial face 214 of the wheel 210. In yet further implementations, the plurality of driven lugs 212 may be disposed in a circular pattern about the longitudinal axis 203, and may be evenly-spaced in such a pattern. In still yet further implementations, wheel may include the same number of driven lugs 212 as the driving lugs 206 of the torque key 200.

Referring additionally to FIG. 2B, a side view of an example wheel set 201 having an example torque key 200 is illustrated, wherein the torque key 200 is mated to, or otherwise engaged with the wheel 210. In some implementations, each of the plurality of driving lugs 206 may be disposed in between, or interlocked with two adjacent driven lugs 212. The driving lugs 206 may engage with the driven lugs 212 such that the plurality of driving lugs 206, or the protruding pattern formed thereof, may interlock or mesh with the plurality of driven lugs 212, or the protruding pattern thereof In some implementations, each of the plurality of driving lugs 206 may be disposed in between, and contacting each of the two adjacent driven lugs 212, such that the driving lug 206 may transfer force to either of the two adjacent driven lugs 212, and vice versa. In further implementations, the driving lugs 206 and the driven lugs 212 may be sufficiently sized such that there is no rotational play or clearance between them when the torque key 200 is mated to, or engaged with, the wheel 210.

In some implementations, the key lugs 208 of the torque key 200 may receive a rotational force from another component, such as a shaft, for example. Such a rotational force may be about the longitudinal axis 203, and result in example rotational force vector 205, about the longitudinal axis 203. In such a situation, the torque key 200 may transfer the torque, or in other words, the rotational force from the key lugs 208 to the driving lugs 206, such that the rotational force vector 205 is transferred to torque vector 207, exerted through each of the driving lugs 206 to the corresponding adjacent driven lug 212. For example, if the key lugs 208 were to receive a clockwise rotational force vector 205, the torque key 200 may transfer the rotational force to the driving lugs 206 such that each of the driving lugs 206 exerts the resulting torque vector 207 against the adjacent driven lug in the clockwise direction, in this example such driven lug being example driven lug 212a. Conversely, if the key lugs 208 were to receive a counterclockwise rotational force vector 205, the example driving lug 206 may transfer the resulting torque vector 207 to the adjacent driven lug in the counterclockwise direction, such as example driven lug 212b. In further implementations, the driving lugs 206 may transfer or exert the example torque vector 207 to each of the driven lugs 212 about the longitudinal axis 203, and without exerting a force on the wheel 210 in a radial direction. In other words, the force or torque transmission from other component by the torque key 200 to the wheel 210 may only be in a rotational manner, about longitudinal axis 203, and may not be in a lateral or radial direction, such that the concentricity between the torque key 200 and the wheel 210 is maintained. In some implementations, when the torque key 200 is engaged with the wheel 210, a clearance gap may exist in between an OD circumference or surface 224 of the torque key 200, and an ID surface 226 of each of the driven lugs 212, as depicted in FIG. 2B. Therefore, in some implementations, there may not be contact between the torque key 200 and the wheel 210 in the radial direction to avoid force being exerted on the wheel 210 in the radial direction.

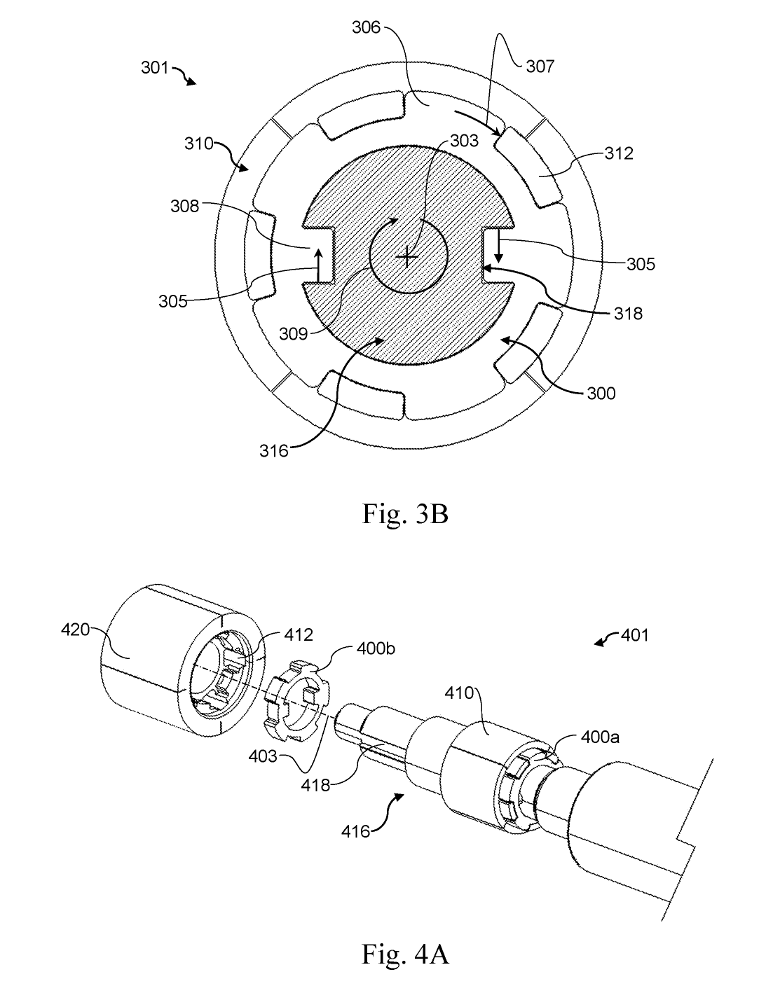

Referring now to FIG. 3A, a perspective view of an example shaft assembly 301 is illustrated, wherein the shaft assembly 301 includes an example torque key 300 and an example wheel 310, as well as a shaft 316. Example torque key 300 may be similar to example torque keys described above. Further, the similarly named elements of example torque key 300 may be similar in function and/or structure to the elements of the other example torque keys, as they are described above. Further, the example torque key 300 and the example wheel 310 may engage with one another as described above regarding the example wheel set 201. The shaft 316 may be a shaft of a roller of an imaging device, in some implementations. In further implementations, the shaft may include a metallic material, such as steel, aluminum, or another suitable metallic material or alloy. In other implementations, the shaft may include a polymer material, or another material. In yet further implementations, the shaft may include a material that may have a hardness that is higher than the material of the wheel 310, and/or the torque key 300. Further, the shaft 316 may rotatably engage the wheel 310 with other components of the imaging device. In some implementations, the shaft 316 may be disposed within or engage with an inner bore 304 of the torque key 300, and a central bore 328 of the wheel 310. In further implementations, the OD of the shaft 316, as well as the ID of the inner bore 304, and the central bore 328 may have size tolerances such that, when the components are assembled or mated together, or otherwise engaged with one another, the shaft 316, the torque key 300, and the wheel 310 may share the same longitudinal axis 303, or that a sufficient degree of concentricity between the three components is achieved. Additionally, the shaft 316 may include a plurality of channels, keyways, or slots 318 that may extend along the length of the shaft 316. In some implementations, the slots 318 may extend parallel to the longitudinal axis 303, and also may extend parallel to one another. In further implementations, the slots 318 may be evenly spaced around an outer circumference or surface of the shaft 316. In some implementations, the shaft 316 may include two slots 318 that may be diametrically opposed to one another across a diameter of the shaft 316. In yet further implementations, the shaft 316 may include the same number of slots 318 as the torque key 300 has key lugs 308. In further implementations, the slots 318 may be oriented around the shaft 316 such that each key lug 308 of the torque key 300 may be received by and engage with a separate slot 318 of the shaft. Therefore, each slot 318 may have a complementary geometry or cross-section to the key lug 308 that the slot 318 is to engage with. In yet further implementations, each slot 318 may have the same cross-sectional geometry, and each key lug 308 may have the same cross-sectional geometry such that any key lug 308 may be received within any of the slots 318.

Referring additionally to FIG. 3B, a side cross-sectional view of the example shaft assembly is illustrated, wherein the shaft 316 is disposed within and engaged with the torque key 300 and the wheel 310. In some implementations, the torque key 300 may be mated to an axial face of the wheel 310 such that the plurality of driving lugs 306 are interlocked with the plurality of driven lugs 312. Further, the shaft 316 may extend through the inner bore of the torque key 300 and the central bore of the wheel 310, the slots 318 of the shaft 316 engaged with the key lugs 308 of the torque key 300. The slots 318 may be engaged with the key lugs 308 such that, if the shaft 316 was to rotate about the longitudinal axis 303, for example in a clockwise fashion, as illustrated, the slots 318 may transfer the rotation 309, and the corresponding torque or moment thereof, to the torque key 300 through the key lugs 308. The transferred torque may be represented by force vectors 305. Additionally, the slots 318 may be disposed such that they transfer the torque to the torque key 300 in a symmetrical fashion, about the longitudinal axis 303. Further, the torque key 300 may then transfer the force vectors 305 into force vectors 307, exerted on each of the driven lugs 312 by the adjacent driving lug 306. For simplicity, the force vector 307 is only illustrated on one of the driving lugs 306 in FIG. 3B, however, such a force vector may be transferred through all of the driving lugs 306 to the corresponding adjacent driven lugs 312 so that the torque is transferred by the torque key 300 from the shaft 316 to the wheel 310 symmetrically about the longitudinal axis 303. The torque key 300 may transfer the torque to the wheel 310 across multiple driving/driven lug interfaces, thus increasing the transfer surface area, and thus increasing the amount of torque that is able to be transferred to the wheel without damaging the wheel or hindering performance of the wheel. Further, the torque key 300 may transfer the torque to the wheel 310 in a rotational direction only, in some implementations, and not in a radial direction, thereby preserving the concentricity between the shaft 316 and the wheel 310. Note, although clockwise rotation and torque is depicted in FIG. 3B, counterclockwise rotation and torque may also be transferred to the wheel 310 by the torque key 300 in a similar manner as described above.

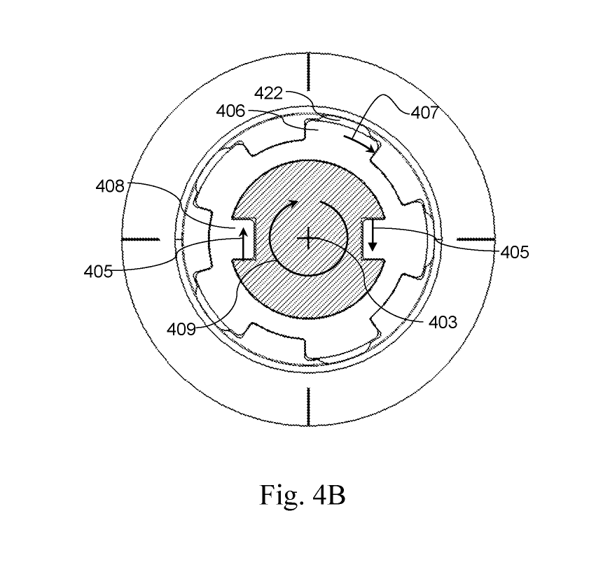

Referring now to FIG. 4A, a perspective view of an example shaft assembly 401 is illustrated, wherein the shaft assembly 401 includes an example torque key 400a, a wheel 410, and a shaft 416. Example shaft assembly 401 and the constituent components may be similar to the example shaft assembly 301 described above. Further, the similarly named elements of example shaft assembly 401 may be similar in function and/or structure to the elements of the other example shaft assembly, torque keys, or wheels, as they are described above. Shaft assembly 401 may further include a second wheel 420 and a second torque key 400b, wherein the wheel 410 may then be referred to as a first wheel 410, and the torque key 400a may then be referred to as a first torque key 400a. The second wheel 420, and the second torque key 400b, may be similar in structure and/or function to the first wheel 410, and the first torque key 400a, respectively. The second torque key 400b and the second wheel 420 may both be disposed on the shaft 416 such that the second wheel 420, the second torque key 400b, and the shaft 416 all share the same longitudinal axis 403, or that a sufficient degree of concentricity between the three components is achieved. Referring additionally to FIG. 4B, a side cross-sectional view of the example shaft assembly 401 is illustrated, wherein the engagement of the second torque key 400b and the shaft 416 and the second wheel 420 is depicted. In some implementations, key lugs 408 of the second torque key 400b may each be engaged with a slot 418 of the shaft 416. Further, a plurality of driving lugs 406 of the second torque key 400b may be engaged with a plurality of drive pockets 412. Each drive pocket 412 may be sufficiently sized and have a sufficient geometry so as to receive one of the plurality of driving lugs 406 when the second torque key 400b is engaged with the second wheel 420. Upon the shaft 416 being rotated about the longitudinal axis 403, for example in the clockwise direction, the slots 418 of the shaft may transfer the torque of the rotation to the key lugs 408 of the second torque key 400b, as illustrated by force vectors 405. The second torque key 400b may then transfer the torque from the shaft 416 to the second wheel 420 through the engagement of the plurality of driving lugs 406 with the plurality of drive pockets 412, as illustrated by torque vector 407. In some implementations, the second torque key 400b may transfer the torque to the second wheel 420 in a rotational manner about the longitudinal axis 403, and may not exert force on the second wheel 420 in a radial direction. In further implementations, each drive pocket 412 may include a clearance gap 422 adjacent to the driving lug 406 so that the driving lug 406 does not transfer force in the radial direction. In some implementations, upon the shaft 416 rotating, both the first and second torque keys 400a and 400b, may each transfer the torque from the shaft 416 to the corresponding first and second wheels 410 and 420, respectively. Note, although clockwise rotation and torque is depicted in FIG. 4B, counterclockwise rotation and torque may also be transferred to the second wheel 420 by the second torque key 400b in a similar manner as described above.

What is claimed is:

1. A torque key, comprising:
an annular body to mate with a wheel, the annular body having an inner bore to receive a shaft;
a plurality of driving lugs extending radially outward from the body, each driving lug to engage with a driven lug protruding from an axial face of the wheel; and
a plurality of key lugs extending radially into the inner bore of the annular body, each key lug to engage with a slot of the shaft.

2. The torque key of claim 1, wherein the key lugs are spaced evenly around the inner bore.

3. The torque key of claim 2, wherein the key lugs are diametrically opposed about the inner bore.

4. The torque key of claim 1, wherein the driving lugs are spaced evenly around an outer circumference of the annular body.

5. The torque key of claim 4, further comprising five driving lugs forming a circular pattern about the circumference of the torque key, the driving lugs to interlock with a plurality of driven lugs of the wheel.

6. The torque key of claim 1, wherein the wheel is a gear.

7. A wheel set, comprising:
a wheel having a plurality of driven lugs protruding from an axial face of the wheel, the driven lugs to be evenly-spaced in a circular pattern about a longitudinal axis of the wheel; and
a torque key to mate to the axial face of the wheel, the torque key comprising:
a ring-shaped body having an inner bore;
a plurality of evenly-spaced driving lugs extending radially outward from an outer circumference of the torque key, the plurality of driving lugs to interlock with the plurality of driven lugs of the wheel such that each of the plurality of driving lugs is to transfer force to either of the two driven lugs adjacent to the driving lug; and
two diametrically opposed key lugs extending radially inward into the inner bore, each key lug to engage with a complementary keyway on a shaft.

8. The wheel set of claim 7, wherein the torque key is to mate to the axial face of the wheel without the driving lugs contacting the driven lugs in a radial direction.

9. The wheel set of claim 8, wherein the torque key is to transfer torque from the shaft to the wheel through the engagement of the driving lugs with the driven lugs, the torque to be transferred to the driven lugs about the longitudinal axis of the wheel.

10. The wheel set of claim 9, wherein the wheel comprises a polymer material and the shaft and torque key each comprise a metallic material.

11. A shaft assembly, comprising:
a wheel having a plurality of driven lugs protruding from an axial face of the wheel in a circular pattern;
a shaft disposed within a central bore of the wheel;
a torque key disposed on the shaft and mated to the axial face of the wheel to transfer torque from the shaft to the wheel, the torque key comprising:
an annular body having an inner bore to receive the shaft;
a plurality of driving lugs extending radially and evenly spaced from the body, each driving lug to interlock with two driven lugs of the wheel; and
a plurality of key lugs extending radially into the inner bore of the annular body, each key lug to engage with a slot of the shaft.

12. The shaft assembly of claim 11, further comprising a second wheel disposed on the shaft.

13. The shaft assembly of claim 12, further comprising a second torque key to transfer torque from the shaft to the second wheel.

14. The shaft assembly of claim 13, wherein a plurality of driving lugs of the second torque key is to engage with a plurality of drive pockets of the second wheel to transfer torque to the second wheel without exerting force on the second wheel in a radial direction.

15. The shaft assembly of claim 11, wherein the wheel comprises a polymer material and the shaft and torque key each comprise a metallic material.
